(19) United States
(12) Patent Application Publication
(10) Pub. No.: US 2014/0310079 A1
(43) Pub. Date: Oct. 16, 2014

(54) SYSTEM AND METHOD FOR ELECTRONIC SOCIAL SHOPPING GAME PLATFORMS

(71) Applicants: Marie-Barbe Girard, London (GB); Nathalie Gaveau, London (GB); Evan Adelman, London (GB); Hoon Kim, London (GB)

(72) Inventors: Marie-Barbe Girard, London (GB); Nathalie Gaveau, London (GB); Evan Adelman, London (GB); Hoon Kim, London (GB)

(73) Assignee: SHOPVOLUTION LIMITED, London (GB)

(21) Appl. No.: 14/237,864

(22) PCT Filed: Aug. 10, 2012
(86) PCT No.: PCT/US12/50457

§ 371 Date: Jun. 24, 2014

Related U.S. Application Data
(60) Provisional application No. 61/666,643, filed on Jun. 29, 2012.
(60) Provisional application No. 61/656,448, filed on Jun. 6, 2012.
(60) Provisional application No. 61/522,571, filed on Aug. 11, 2011.

(51) Int. Cl. G06Q 50/00; G06Q 30/02; G06F 17/30

(52) U.S. Cl. CPC G06Q 50/01; G06F 17/30864; G06Q 30/0214
USPC 705/14.16

(57) ABSTRACT

The present disclosure relates generally to systems and methods for social shopping networks. In one embodiment, a computer-implemented method for providing rewards to a user and a customer via a social shopping game platform associated with a networking Web site includes the steps of receiving registration information for the user; receiving product information of at least one product from a merchant; enabling the user to create a user's personal store, wherein the user's personal store displays the product information of the at least one product; enabling a customer of the networking Web site to purchase the at least one displayed product from the merchant; and distributing the rewards to the user and the customer for their activities, such as, if the customer makes a purchase from the merchant after visiting the user's store displaying the at least one product.

### CROSS REFERENCE TO RELATED APPLICATIONS

This application claims priority to: U.S. Provisional Application Ser. No. 61/522,571, filed on Aug. 11, 2011; U.S. Provisional Application Ser. No. 61/656,448, filed on Jun. 6, 2012; and U.S. Provisional Application Ser. No. 61/666,643, filed on Jun. 29, 2012. Priority to these provisional applications is expressly claimed, and the disclosures of the respective provisional applications are hereby incorporated by reference in their entireties for all purposes.

### FIELD OF THE INVENTION

The present disclosure relates generally to systems and methods for social shopping networks and more particularly, but not exclusively, to systems and methods for promoting electronic commerce (“e-commerce”) through personalized shopping experiences in a social shopping network, such as by allowing users to set up personal stores for showcasing products and services from across the Web, network with other users, and earn rewards, especially, but not only, when other users make online purchases.

### BACKGROUND OF THE INVENTION

There exists a growing ecosystem that supports electronic commerce (“e-commerce”) and digital gaming industries. This ecosystem includes a variety of channels and user behaviors. From the user's perspective, the ecosystem includes, but is not limited to, social networking platforms, social gaming, and e-commerce Web sites for shopping.

A variety of social networking Web sites allows a user to establish a network of relationships with other users of these sites. A user may be “linked” to other users that share common interests, activities, beliefs, and the like. These other users commonly are referred to as friends, contacts, associates, followers, and so on. A social networking Web site typically includes a virtual representation of each user (e.g., a profile), social Web links of interest to the user, photos selected by the user, and a variety of other services. A user of a social networking Web site may be provided with one or more personal Web pages. These Web pages may include various information about the user, such as a list of his/her contacts, photos, location, date of birth, interests, activities, photos, messages from the user or his/her contacts, and the like. Examples of social networking platforms include, but are not limited to, Facebook®, Twitter®, Google+®, Instagram®, MySpace®, LinkedIn®, and the like.

From a brand or company's perspective, the ecosystem includes e-commerce Web sites, advertisements (e.g., modeled on a pay per click basis), affiliate marketing used to drive sales on retailers' Web sites, and so on. Among the various channels, e-commerce is an increasingly popular medium to reach consumers/users. For example, in the United Kingdom (“UK”), the average annual online spending per person was roughly £1,600 ($2,224)—higher than anywhere else in the world. Saving money is a primary motivation; the average UK household saved £1,000 ($1,390) in 2009 by shopping online, as the Boston Consulting Group (“BCG”) reported in 2010. Furthermore, receiving recommendations from friends and trusted users throughout the purchase process is another key motivating factor. In fact, Nielsen reported that 90% of consumers trust recommendations from their friends and 62% of consumers consult online communities before making a purchase.

Pay per click (also called “cost per click”) is a pay per performance method of advertising used to direct traffic to Web sites. Advertisers pay the publisher when an advertisement is clicked. Two methods often are used for determining the value of a click. Advertisers can price the click value by bidding on keyword phrases and placements relevant to their target market. Alternatively, content sites (i.e., advertisers) arrange and charge a fixed price per click.

Similarly, affiliate marketing is a pay per performance method used to drive visits and sales on the retailers' Web sites. Specifically, a retailer rewards one or more affiliates for each user brought about by the affiliate's own marketing efforts. Affiliate marketing networks (e.g., Commission Junction®, TradeDoubler®, Affiliate Window®, Pepperjam Network®, LinkShare®, and so on) coordinate the interaction between the large aggregate of affiliate Web sites and brands to drive product sales and generate commissions for the affiliates.

Many of the social networking Web sites described above also allow users to interact with each other, for example, through electronic mail (“e-mail”) and instant messaging services. Revenue from these Web sites may be generated via subscriptions paid by the users of the Web site. In addition, the Web sites may generate revenue by providing space on the Web site for online advertising. If a social networking Web site satisfies the needs of a user, he/she may become a loyal user of that particular Web site. As the number of loyal users of a Web site increase, the number of subscriptions and fees for online advertising may also increase. As a result, the revenue generated by the Web site also increases.

Apart from social networking Web sites, the marketplace has provided loyalty programs for consumers. These programs may include offering rewards to consumers for certain actions (e.g., purchasing a particular item, providing a referral, and the like). The rewards may be instantaneous (e.g., monetary reward, points that may have monetary value, etc.), but also include discounts on a current/future purchase or periodic rewards. Loyalty programs, however, do not exist in connection with social networking Web sites. Moreover, loyalty programs do not exist in the context of social gaming within a social network Web site or affiliations that distribute rewards for certain actions performed by the user of the Web site, such as building a shop, populating the shop with products, promoting a product, personally recommending a product to others, and the like.

There have been a few attempts—experimenting with the social space, brand and product placement, monitoring user feedback on brands and products through social networking interactions (e.g., McDonald's® campaign on FarmVille from Zynga® or a Brooks Brothers'® store on Facebook®)—at drawing upon social networks and social gaming mechanics to drive additional sales. However, additional tools and platforms are emerging, bringing the e-commerce store directly into social networking platforms (e.g., Pinterest®, Thefancy®, Lyst®, Polyvore®, ShopFans®, ShopTab®, and Milyoni®).

Unfortunately, although affiliate marketing and cash back programs are efficient sales channels, these approaches don't generate brand loyalty, relevancy, engagement or virality from their users. On the other hand, social gaming mechanics are intrinsically social, fun and engaging, but remain disconnected from the real-world e-commerce experience. Accordingly, a need exists for an improved system and method for electronic social shopping game platforms in an effort to overcome the aforementioned obstacles and deficiencies.

### BRIEF SUMMARY OF THE INVENTION

The present disclosure relates generally to systems and methods for social shopping networks and more particularly, but not exclusively, to systems and methods for personalizing shopping experiences to synergize the efficacy of performance marketing programs with the loyalty and engagement of social networking and game mechanics in an electronic social shopping network. In one embodiment, a computer-implemented method for providing rewards to a user and a customer via a social shopping game platform associated with a networking Web site includes the steps of receiving registration information for a user; receiving product information of at least one product from a merchant (or directly from an e-commerce site); enabling the user to create a user's personal electronic store, wherein the user's personal electronic store displays the product information of the at least one product from the merchant; enabling a customer of the networking Web site to purchase the at least one displayed product in the user's store from the merchant's Web site; and distributing the rewards to the user and the customer for their activities, including but not limited to, if the customer makes a purchase on the merchant's Web site after visiting the user's store displaying the at least one product from the merchant.

Alternative embodiments of the disclosure further relate to a system and a tangible computer-readable medium for providing rewards to a user and a customer via a social shopping platform associated with a networking Web site, consistent with the method previously described. Embodiments of the invention also relate to an apparatus for performing the computer-implemented method.

Aspects of embodiments of the invention, including various novel details of implementation and a combination of elements, will now be more particularly described with reference to the accompanying drawings and delineated in the claims. It will be understood that the particular methods and systems described herein are shown by way of illustration only and not as limitations. As will be understood by those skilled in the art, the principles and features described herein may be employed in various and numerous embodiments without departing from the scope of the teachings herein.

### BRIEF DESCRIPTION OF THE DRAWINGS

In order to better appreciate how the above-recited and other advantages and objects of the disclosure are obtained, embodiments thereof will now be described by way of example with reference to the accompanying drawings. It should be noted that the components in the figures are not necessarily to scale, emphasis instead being placed upon illustrating principles of the disclosure. Moreover, in the figures, like reference numerals designate corresponding parts throughout the different views. However, like parts do not always have like reference numerals. Moreover, all illustrations are intended to convey concepts, where relative sizes, shapes, and other detailed attributes may be illustrated schematically rather than literally or precisely.

FIG. 1 is a block diagram of illustrating one embodiment of an environment in which the present systems and methods may be implemented.

FIG. 2a is an illustration of one embodiment of a user interface of the present system.

FIG. 2b is an illustration of another embodiment of a user interface of the present system.

FIG. 3 is an illustration of one embodiment of the virtual store attendants of the present disclosure in one embodiment of a user interface of the present system; and

FIG. 4 illustrates an exemplary computer architecture for use with the present system, according to one embodiment.

### DETAILED DESCRIPTION OF THE PREFERRED EMBODIMENTS

In the following description, for purposes of explanation, specific nomenclature is set forth to provide a thorough understanding of the various inventive concepts disclosed herein. However, it will be apparent to one skilled in the art that these specific details are not required in order to practice the various inventive concepts disclosed herein.

In one embodiment, a computer-implemented method for providing rewards to a user and a customer via a social shopping game platform associated with a networking Web site includes the steps of receiving registration information for a user; receiving product information of at least one product from a merchant (or directly from an e-commerce site); enabling the user to create a user's personal electronic store, wherein the user's personal electronic store displays the product information of the at least one product from the merchant; enabling a customer of the networking Web site to purchase the at least one displayed product in the user's store from the merchant's Web site; and distributing the rewards to the user and the customer for their activities, including but not limited to, if the customer makes a purchase on the merchant's Web site after visiting the user's store displaying the at least one product from the merchant.

Alternative embodiments of the disclosure further relate to a system and a tangible computer-readable medium for providing rewards to a user and a customer via a social shopping platform associated with a networking Web site, consistent with the method previously described. Embodiments of the invention also relate to an apparatus for performing the computer-implemented method.

This apparatus may be specially constructed for the required purposes, or it may include a general-purpose computer selectively activated or reconfigured by a computer program stored in the computer. Such a computer program may be stored in a computer-readable storage medium, such as, but not limited to USB drives, internal or external hard drives, floppy disks, optical disks, CD-ROMs, magnetic-optical disks, read-only memories, random access memories, EPROMs, EEPROMs, magnetic/optical cards, or any type of media suitable for storing electronic instructions, each coupled to a computer system bus.

The methods presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

As used herein, the term “performance marketing” is a type of performance-based marketing in which a business rewards one or more affiliates for each visitor or customer brought about by the affiliate's own marketing efforts. The industry comprises at least four principle entities: a merchant (also known as an “advertiser,” a “retailer,” or a “brand”); a network (providing offers for the affiliate to choose from and also enabling payments); a publisher (also known as an “affiliate”); and a customer. Affiliate marketing is commonly confused with referral marketing, as both forms of marketing use third parties to drive sales to the retailer. However, both are distinct forms of marketing, a significant difference being that affiliate marketing relies purely on financial motivations to drive sales while referral marketing relies on trust and personal relationships to drive sales. Affiliate marketing is also called “performance marketing,” in reference to how sales employees are typically being compensated. Such employees are typically paid a commission for each sale they close, and sometimes are paid performance incentives for exceeding targeted baselines. Affiliate marketing programs use many revenue sharing and compensation methods, including, but not limited to, Cost Per Action (CPA) (e.g., where an action includes sales), Cost Per Click (CPC), Cost Per Lead (CPL), and/or Cost Per Mile (CPM). Cost Per Action methods require that referred visitors do more than visit the retailer's Web site before the affiliate receives commission. The advertiser first must convert that visitor. Accordingly, it is in the best interest for the affiliate to send the most closely targeted traffic to the retailer as possible to increase the chance of a conversion. The risk and loss is shared between the affiliate and the retailer. In most cases, compensation is a fixed fee, except where the action is a sale and the compensation may be a percentage of the transaction.

As used herein, “product” refers to both goods and services.

The term “reward,” as used herein, refers to cash, points, credits, and other similar rewards.

The term “merchant,” as used herein, describes a retailer associated with the system that has a Web site from which customers can purchase products. Once the merchant enters into an agreement to join the system of the present invention, the merchant also is referred to as an “advertiser.”

As used herein, “social gaming mechanics” are the logic and rules behind the activity or practice of playing an online game or competition on a social media platform.

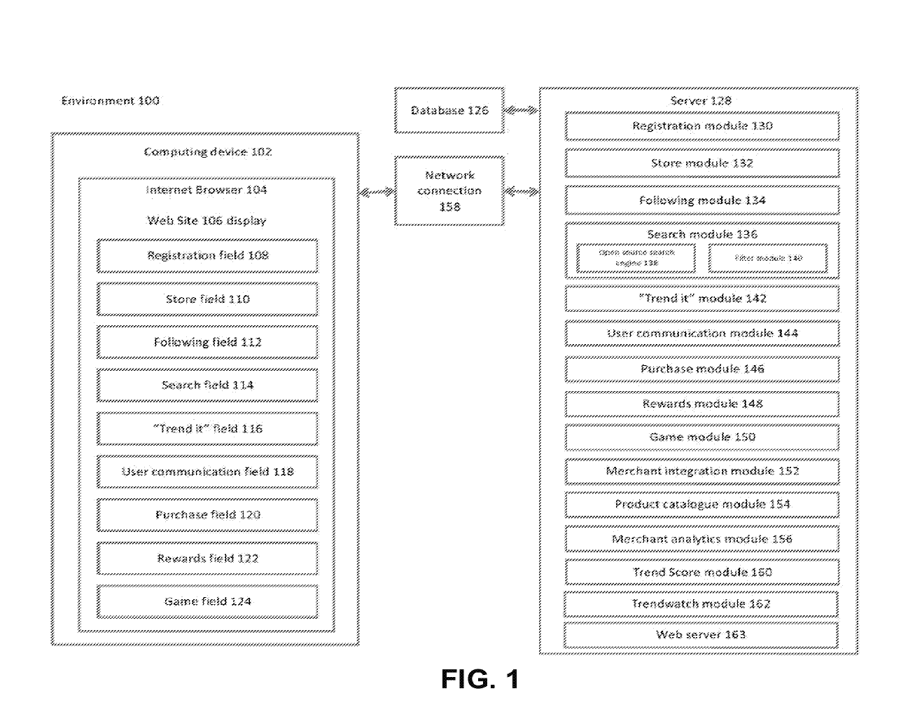

As previously discussed, conventional methods for affiliate marketing and reward systems are efficient sales channels; however, these methods may not generate brand loyalty, engagement, and virality. Social networking platforms—which provide a target audience of users/consumers for promoting virality—have steadily increased, yet remain disconnected from real-world e-commerce applications. Turning to FIG. 1, a network-based environment 100 for promoting electronic commerce (“e-commerce”) through personalized shopping experiences is illustrated.

### Computing Device/Server Communication

In one embodiment, environment 100 includes a computing device 102 configured to communicate with a server 128 across a network connection 158, such as the Internet. However, one of ordinary skill in the art would appreciate that network connection 158 may include one or more Local Area Networks (“LANs”), a Wide Area Network (“WAN”) (e.g., Internet Protocol (“IP”) network), and/or mobile/cellular wireless networks connected to one another. Communication/data exchange with network connection 158 may occur via any common high-level protocols (e.g., Transfer Control Protocol (“TCP”)/IP, User Datagram Protocol (“UDP”), and so on) and may comprise differing protocols of multiple networks connected through appropriate gateways. This communication/data exchange supports both wired and wireless connections.

### Web Site Access

The computing device 102 may be a personal computer, a laptop, a personal digital assistant (PDA), a smart phone, a tablet, or any other type of computing device. In one embodiment, the computing device 102 includes an Internet browser 104. The browser 104 is typically an application or program installed on the computing device 102 to display information aggregated by Web server 163, which is hosted by the server 128. For example, the Internet browser 104 may display a Web site 106 on the computing device 102. The Web server 163—uniquely identifiable via Uniform Resource Locators (“URLs”)—may be hosted or stored on the server 128. The Internet browser 104 accesses the Web server 163 across the network connection 158 using any common networking protocol (e.g., HyperText Transfer Protocol (“HTTP”), HTTP Secure (“HTTPS”), Transport Layer Security (“TLS”), Secure Sockets Layer (“SSL”), and the like) requests and displays the transmitted information as a Web site 106 display, for example, on computing device 102.

### Registration

The Web site 106 may include multiple Web pages, each uniquely identifiable via URLs. In one embodiment, a first Web page may include a registration field 108 and public information (not shown). A user may enter registration information into the registration field 108 to gain access to additional Web pages of Web server 163. For example, a user may enter an existing username and password in the registration field 108. Alternatively, a user may create a new account by entering information into the registration field 108. When the user registers with the Web site 106, the information is submitted over the network connection 158 to a registration module 130, served through Web server 163. In yet another embodiment, users also may register using an existing social networking platform (e.g., Facebook®, Twitter®, Google+®, e-mail, and so on) and information is transmitted to registration module 130 through Web server 163. The registration module 130 may be stored on server 128 and is configured to create a user profile with the submitted information. In one embodiment, database 126 stores information regarding registered users (i.e., subscribers) of the Web site 106.

### Database

The server 128 communicates with the database 126 to provide data to the database 126, retrieve data from the database 126, or analyze data stored in the database 126. For example, the database 126 may store the username and password of a user that is a subscriber to the Web site 106. Registration module 130 analyzes information provided in the registration field 108. The registration module 130 may compare the information in the field 108 with information stored within the database 126. For example, the registration module 130 may compare a username and password provided in the registration field 108 with user names and passwords stored in the database 126. Based on this comparison, the registration module 130 determines whether a user has properly signed in (or logged in) to the Web site 106. Once the user has signed in or subscribed to the Web site 106, the user may have access to content provided on Web server 163. However, some content on the Web server 163 may be open to the public, and it may not be necessary for a user to provide registration information in the registration field 108.

### Public Information

For example, the public information may include information for all visitors to the Web server 163, regardless of whether the visitor is a registered user (i.e., subscriber) of the Web site 106. The public information may include a following field 112 for browsing popular (e.g., “trending”) products, a search field 114 for searching the products catalogue (e.g., searching categories, brands, or deals), a rewards field 122 for displaying the current rewards accessible to registered users (e.g., coupons, vouchers, samples, or other perks), a people field (not shown) for browsing popular (e.g., “trending”) users' personal stores and accessing these stores in a store field 110 (e.g., including the information about items, such as products or services in each user's store), and a purchase field 120 allowing any user—registered or unregistered—to purchase a displayed product from a merchant/partner Web site.

The Web server 163 may also include multiple pages that may only be accessed by a subscriber to the Web site 106. In other words, a registered user that successfully provides sign in or login information on a first Web page may access all the additional Web pages or a portion of the additional Web pages.

### Personal Store

After the user has registered, the user is enabled to set up an online personal store in the store field 110 and becomes a “shopkeeper” using a store module 132 to feature their favorite products from a products catalogue stored in the database 126 via a product catalogue module 154 of the server 128. In one embodiment, the user finds products from the product catalogue module 154 using the various options available in the search field 114.

Alternatively, the user/shopkeeper sets up their store in a few clicks using ready-made designs/templates within the system. Server 128 provides a user with an automatic/predefined store, where products are suggested for each user based on their digital profile from the registration field 108 and registration module 130 (e.g., from social networking activity or browsing history).

In one embodiment, users can promote products they value, for example, by using the various options available in a user communication field 118. In particular, users can add comments on products, obtain product information from the products catalogue module 154, and share them with their friends via the user communication field 118 via a user communication module 144.

In order to facilitate social networking over environment 100, the user communication module 144 may include, but is not limited to, the following functionalities in Table 1.

TABLE 1
Example functionality of user communication module 144

| Feature | Objective/Benefit |
|---|---|
| Sharing a user's shop, | Various sharing functionalities can be |
| list, or products | used to broadcast one's store, list, or products |
| | through social networks |
| Posting reviews | Users add reviews to products in their store |
| | or to products in other user's stores |
| Tagging products | Users tag products to associate products |
| | with specific interests, people, or activities |
| Dialogue between users | Users can communicate with other |
| | users by commenting on their store or |
| | by sending private messages/questions |

The user's selection of products can feature in multiple digital environments, including the user's social network page, the system's Web server 163, mobile platforms, tablet device applications, application programming interfaces (APIs), and so on. Therefore, server 128 provides the additional advantage for combining the power of word-of-mouth advertising with the phenomena of social gaming and social networking Web sites to create revenue for merchants at a minimal cost that may replace both advertising dollars and money spent on purchasing or preparing demographic information regarding purchases of certain items.

### “Trend it”

In yet another embodiment, the user may download products that are not yet featured in the product catalogue module 154 by using the system's “Trend it” button (i.e., a “Trend it” field 116). “Trend it” field 116 allows users to capture product information, which may include various product information, such as, but not limited to, photos, description, meta content, videos, pricing, usage suggestions and similar product features. If the retailer of a product has already entered into an agreement to list their products in product catalogue module 154, “Trend it” field 116 allows users to add products directly from the merchant's Web site by making use of the “Trend it” module 142 of server 128 to import the product information directly from the merchant's Web site into the database 126. Alternatively, “Trend it” field 116 enables users to submit an e-commerce Web site that they would like to be listed on the server 128. Further, “Trend it” field makes use of the Following module 134 allowing users to save other information about the products such as brand, retailer, and product category to their profile stored in database 126 to further influence data displayed via a Trendwatch module 162, a rewards module 148, and a game module 150.

In another embodiment, users may also upload their own photos or videos via mobile or online communication, or scan items at points of sale. The products the user adds may include products the user owns, products the user wishes for, or products the user likes—the user does not need to own the product.

### Lists

Store field 110 may also display recommendations for one or more particular products or services that have been selected by a user/shopkeeper of the Web site 106. The user is able to group products within his/her store into different lists. Lists can be populated based on a product category, a brand, an event or occasion (e.g., wedding list or birthday list), a purpose, a time of year, and so on. In one embodiment, users create a “wishlist” to feature products they would like to receive and are notified of any purchase made from their list. Birthday notifications received from social networking sites provide a link to the user's “wishlist.”

### Followers/Following

In one embodiment, the user/shopkeeper can use the user communication field 118 to recommend their shop to their existing friends and followers in Web site 106 and/or other social networks via the user communication module 144 of the server 128. The user's existing friends and other users they are following in their social network(s) are automatically followed by the user in Web site 106 when they become registered users of the Web site 106. In addition, users can decide to follow other users' stores, brands, and/or product categories, thereby becoming a “follower” of these stores, brands, and/or product categories.

As previously mentioned, following field 112 is provided for browsing popular (“trending”) products based on the user's profile, interests, and connections. This allows users to easily promote and find products they value and appreciate. The Following field 112 provides a customised feed of products to each user based on their social circle and shopping interests (“the interest graph”); it is comprised of the latest products added through a product catalogue module 154 by friends of the user or other users he/she follows, as well as latest products added from brands and/or product categories he/she opted to follow. In another embodiment, advertisers are enabled to bid for product placements targeted at specific groups of users within the following Field 112.

The subscriber/user is enabled to publish their online personal store on existing social network Web sites, in addition to Web site 106, to feature their favorite products and services. The user may obtain product information from the system's product catalog module 154 and share that information with their friends and followers on these other social network Web sites.

In one embodiment of the invention, users are “matched” with other users with similar tastes based on their activity in environment 100. An “affinity score” is calculated to measure the similarity of tastes among different users. This score may be based on users' activity, e.g., one user frequently visits another store, adds the same products or follows the same brands/categories.

The game dynamics within environment 100 (game field 124) are used to create competition and collaboration between users, whose objectives are to maximize their store visitors, followers, and sales. Active participation and social interaction are rewarded and allow user shopkeepers to progress in the game and enhance their stores. In one embodiment, users are able to design their own store backgrounds or avatars and import them into their user profile.

In another embodiment, the following module 134 may be accessed to notify the user when they are physically near users, brands, products, or retailers that they follow.

### Rewards

Rewards field 122 allows users to earn rewards, including, but not limited to cash or points, through their active participation within environment 100, social interaction, successfully inviting other users/friends to become subscribers, purchases through the platforms and sales generated via their store. Users can reinvest these rewards (as well as additional cash) into their store (in efforts to improve size, decoration, staffing, promotion tools, etc.) to drive additional visits or sales, or use their rewards to redeem perks such as coupons, vouchers, samples, invitations to events, or other similar perks (i.e., via rewards field 122). In one embodiment, users also can exchange their points for cash or charity donations under certain conditions. In an alternative embodiment, users also can spend their rewards to purchase tickets for lotteries, sweepstakes, and other temporary campaigns, through which they may win products from the product catalogue of product catalogue module 154.

In order to process rewards, the server 128 may further comprise the rewards module 148. The rewards module 148 distributes rewards and other benefits to users, in connection to purchases made through their personal store on the advertiser's Web site. The rewards module 148 may distribute a portion of the commission from the sale on the retailer's site between the user/shopkeeper and the buyer.

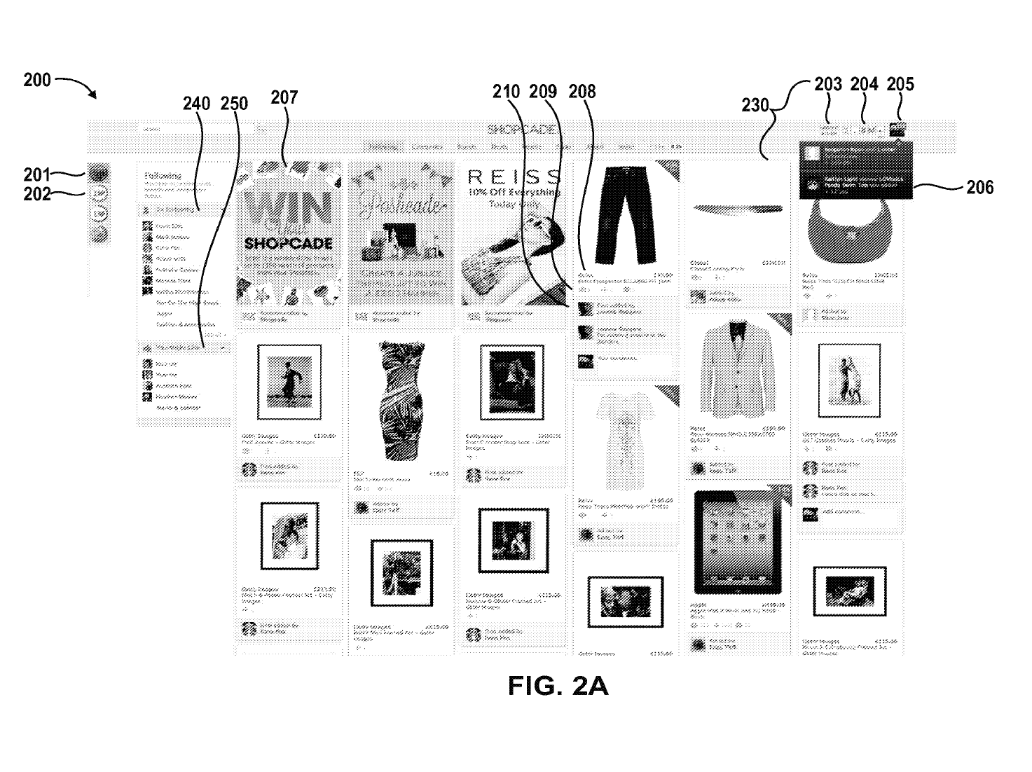

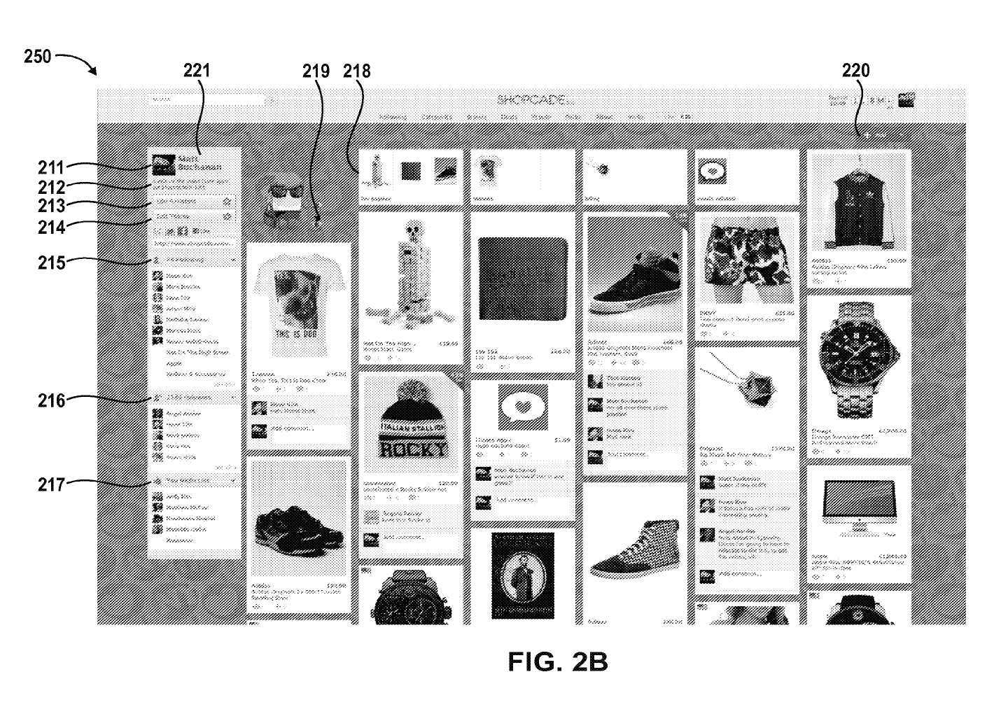

A commission is generated from the clicks or sale of an item on the participating retailer's Web site. User's connections (e.g., friends and followers) buy products from the retailer's e-commerce Web sites via user's store (e.g., store field 110). As one of ordinary skill in the art would appreciate, the consumer traffic driven to retailers' e-commerce Web sites by users' stores is monitored using cookies or promotion codes. The user store includes a notification dashboard where actions (e.g., clicks and purchases) generated by their store and other users are reported. One embodiment of the user's notification dashboard is shown in FIG. 2A and FIG. 2B, which will be discussed in detail below. The user and consumer may get a share of the retailer's commission, either as cash paid into their own account (earnings), points, or a discount at purchase. The commissions are handled by the rewards module 148.

The rewards module 148 may distribute the commission from the clicks/sale of a product from a merchant's Web site via the Web server 163. The rewards module 148 may distribute the reward from the sale in at least three ways. Part of each commission can be kept by the system and the remainder can be split between the user/shopkeeper and the buyer. From the total commission, a part can be added to the shopkeeper's own account after the purchase. In one embodiment of the invention, the user's commission can be cashed out when the purchase is confirmed by the advertiser. In another embodiment, the user's commission can be used immediately as points in the system to redeem perks through the rewards field 122.

In yet another embodiment, a portion of the commission may also be reserved for special payout pools. These payout pools may be associated with certain products, merchant categories, or brands. Winners of the pool will be selected based on preset and communicated goals (e.g., sell the most merchandise from a brand in the first week of February or drive the most sales for sporting goods products). The Rewards module 148 distributes the commission from the payout pools on a recurring basis (e.g., weekly, monthly, or annually).

A purchase field 120 allows any user to purchase a displayed product from an advertiser's Web site. Any other user—including people whom the user may not know at all—can purchase from the user's store, thereby enabling a reward system. Rewards can be linked to the products the user adds to his or her store, the price of the respective products, and the level of the commission paid by the advertiser.

In one embodiment, anyone who creates a store (e.g., by becoming a subscriber described above), logs in, and is active within the system is eligible to earn rewards via a rewards module 148. Accordingly, a user does not have to add/contact friends and followers from their social network to get rewards; however, the highest rewards are earned by successfully inviting friends to become subscribers, and making purchases/generating sales through the server 128. Any user who selects (e.g., clicks) products listed in a user's store and buys the item might earn rewards.

After the user adds a product in his or her store, the product gets shared on the following field 112 (i.e., “trending feed”) maintained in server 128. Users may optionally publish the item on various social networking platforms, whereby the user can also proceed to recommend his or her store and its products to friends and followers. The user promotes their store and the respective products using the user communication field 118 from the user communication module 144. The key objective of the user once they have joined the system is to maximize the number of visitors to their store, customer satisfaction, and sales. To do so, the user may use a range of “merchandising tools” in the user communication field 118 from the user communication module 144. These “merchandising tools” include, but are not limited to, store decoration, promotion, special events, and so on. The more active users are in the Web site 106, the more they expand their social circle (i.e., friends, followers, following, and the like) and their rewards. Therefore, these “merchandising tools” promote both a competitive and a collaborative environment. Competition between shopkeepers may be fostered by a number of periodically generated leaderboards or charts. These leaderboards can be from various categories, including, but not limited to, user with the highest trendsetter score, most visited store, best product mix, most innovative products, highest sales, best customer satisfaction, best by product category or brand, etc. In order to be successful, shopkeeper users are encouraged to build a strong social network (e.g., entering commercial partnerships with other users, joining product-themed and location-based communities, and sending gifts to friends to receive gifts in return).

### Games and Missions

In one embodiment, users are invited, in a game field 124, to perform missions to earn points and other rewards, via the game module 150. Missions may include, but are not limited to, “Matcheroo” (i.e., a mission aimed at matching friends with products), branded missions (e.g., “add to unlock” where users have to add one or several products from a brand to unlock a reward from this brand and “follow to unlock” where users have to follow a brand to unlock a reward from this brand), “nominate your shopping gurus” where users are invited to create an entourage of shopping “gurus” by nominating friends as experts in different product categories, missions to enter sweepstakes, and “Lucky Dip.”

In another embodiment, the game module 150 enables the user to choose from a variety of game applications, missions and game mechanics to use in his or her store including, but not limited to, “Platformer,” “Puzzle,” “Shooting,” “Casino,” “Action,” “Memory,” “Musical,” “TV Gameshow,” “Sales Character,” “Race,” “Memory Game,” “Spot the Difference,” “Identify the Logo,” “Jigsaw Puzzle,” “Retail Trivia,” “Voucher Bonanza,” “Guess Whose Store,” mixtures thereof, and other similar game mechanics. A game module 150 may include the following functionalities in Table 2. The functionalities in Table 2 are associated with the category of games associated with the user's store which can be played with not only other subscriber users but also members of other existing social networks.

TABLE 2
Example functionality of game module 150 associated with a user store

| Feature | Objective/Benefit |
|---|---|
| Group promotions | Promotion on key products, i.e., attract 10 users to buy |
| | and receive a rewards/deal |
| Match users to other users/stores | Make fun, game-like way to discover new users and |
| based on product interaction and | their stores, understand “me” as a user and what fits me |
| purchases | |
| “Guess Whose Store?” | From among your friends or celebs; |
| | Game-like experience . . . poll style, quiz |
| Groups (themed or interest based) | Open vs. Exclusive; |
| | Gain access to groups through level system; |
| | User-created groups (“I love dogs”); |
| | Notification of purchases |
| Leaderboards/Top Charts | Within a user's social network or global users, |
| | e.g., best product selection, best looking, most |
| | entertaining, most visitors, best use of apps, best |
| | customer service; |
| | Enable users to e-mail store owners with questions about |
| | products in their store |
| Shop Analyzer | Titles or categories based on the store user has made; |
| | Assuming categories to enhance the game aspect |

The Game module 150 also may include but may not be limited to the following functionalities in Table 3. The functionalities in Table 3 are associated with the category of games initiated by server 128.

TABLE 3
Example functionality of game module 150 associated with server 128

| Feature | Objective/Benefit |
|---|---|
| Celebrity Stores | Launch as mystery so users have to compete to guess celebrity |
| | identity based on the store contents; |
| | Leverage existing product/brand relationships with celebrities |
| Daily Treasure Hunt | Within server 128 database, find editorially determined product; |
| | Surface interesting/non-mainstream products to users; |
| | Present product as a riddle to enhance game aspect |
| Weekly/Daily | Examples: Build the best store/product mix for a certain theme |
| Challenge/mission | (e.g., best items for dogs); |
| | Brand specific competition; |
| | Merchant specific competition; |
| | Category specific competition |
| Minigame | Allow users to incorporate minigames in their stores; |
| | These minigames can be provided through an open platform |
| Discovery Quiz | In-game quizzes to discover new stores and products |
| Missions | In-game missions around products, merchants, brands or categories |
| | to earn virtual currency or virtual goods |
| Interaction with users' | Possibility for users to interact with the avatar of a store owner |
| avatars | |

### Additional Functionalities

Additional functionalities may be available to the user. These may include but may not be limited to the following functionalities in Table 4.

TABLE 4
Additional example social/navigational functionality associated with server 128

| Feature | Objective/Benefit |
|---|---|
| Product/Brand Suggestor | Fill out questionnaire for server 128 to recommend |
| | products and brands for user |
| Voucher Feed | Feed vouchers to users (shoppers and/or store owners) to |
| | correspond to product mix; |
| | Drive sales, incite impulse buying |
| Auto-adds new items to your store | Automate store populating; |
| based on certain parameters set by | Bring new products to light for store owners |
| app user | |
| Mobile app | Trends feed based on users' location; |
| | Scan product bar codes with mobiles to add products to |
| | store or to recommend products |
| Flash Sale Alert | Tell users when limited time products are in catalogue; |
| | Drive impulse buys |
| Apps can be plugged into a user's | Create ecosystem that enables fast extensions of the user |
| store, gifted to other users, built and | experience |
| promoted by brands | |
| Price comparison widget | Allow price comparisons between similar products from |
| | different retailers |
| Brands widget | Widgets allowing brands to feature branding with their |
| | products on their store/site/social networking page/blog |
| Cross-filtering | Possibility to cross filter to see only products from a |
| | specific category, specific brand, or merchant and specific |
| | people or friends with these products in their user store |
| Newsfeed of trends activity from | Keep user connection to user's shop activity on a daily |
| people in the user's network | and/or weekly basis; |
| | Encourage competition with other users/friends on |
| | sales/activity levels |

### Trend Score

In order to reward users for active participation, the influence of users on the community also can be measured through a “Trendsetter Score,” or “Trend Score.” This score measures the reach of each user and his/her ability to start trends. User Trend Score measures the engagement & influence of a user by tracking activity from various different types of internal actions (e.g., user activity within environment 100) and external actions (e.g., user activity measured from other Internet-based sources), and then distilling the total sum of actions into a more meaningful value, which may range from 0 to 100, where 0 would be least popular and 100 would be most popular. The value of each action (known as “User Trend Points”) in the overall calculation may be worth more or less depending on its importance. The Trend Scores are calculated by a trend score module 160.

Each user has a unique total number of “User Trend Points” for each of the measured actions; this total number increases every time an action occurs. The more recent the action is, the more “User Trend Points” the user gets. For example, an action that occurred today is more valuable compared to an action that occurred one month ago, to the extent that the earlier (i.e., one month old) action is worth nothing in the “User Trend Score.” There is a base value that is constantly rising every second that is the same for every subscriber user. When the user earns “User Trend Points” from an activity, this constantly rising base value is included in the equation.

To calculate the “User Trend Score” from the number of “User Trend Points,” the “User Trend Points” are compared to the base value, which grows every second. Therefore, the “User Trend Score” of an inactive user continues to decrease over time because the “User Trend Points” earned a month ago are worth significantly less than “User Trend Points” earned by all other users one month later. In one embodiment, the “User Trend Score” is calculated based on various actions, each action receiving a certain number of “User Trend Points,” having a certain base value and a certain weight, which can be defined as the maximum earned points possible for the respective action.

A “User Trendsetter Score” typically can increase when other users view or add products he/she added, when other users visit his/her store or lists, follow his/her store or lists or promotes the product through social media (e.g., Facebook® “like” a store/list). Successfully inviting friends to subscribe also can increase a “User Trendsetter Score.” It is possible for two users to have the same “User Trend Score.” For granularity, “Trendsetter Scores” can be measured to the second decimal place. For example, a highly engaged user could score around 95.21, whereas a less engaged user could score around 19.67. In another embodiment, brand-specific “Trendsetter Scores” are calculated for each user, based on their level of engagement with a specific brand and how successful the user is at promoting the brand's products. Reaching a certain level of “Trendsetter Score” can enable users to unlock certain perks and rewards in the rewards field 122.

As an example, the following actions can earn “User Trend Points” that contribute towards the overall “User Trend Score.” Internal actions (i.e., within environment 100) can earn “User Trend Points,” such as, views of products that the user stocks, views of the user's “lists,” adds of products that the user stocks, views of the user's store, the number of followers, the number of successful invites, and general actions of the user (e.g., viewing another user's store and/or list, viewing or adding products from the products catalogue of products catalogue module 154, creating new ‘lists”). External actions (i.e., outside of environment 100), can also earn “User Trend Points,” such as, number of friends on social media sites (e.g., Facebook®), interactions on social media sites (e.g., “likes” received, comments on “wall,” and so on), number of followers on Twitter®, interactions on Twitter® (e.g., retweets, favorites, direct messages, and so on), and activity and engagement from users on other relevant social platforms (e.g., Pinterest®, Youtube®, and others).

Similar to “User Trend Score,” a “Product Trend Score” measures the popularity of a specific product by tracking activity for various different types of internal actions (i.e., product activity within environment 100) and external actions (i.e., product activity measured from other Internet sources), and then distilling the total sum of actions into a more meaningful value ranging, for example, from 0 to 100, where 0 is least popular and 100 is most popular. The value of each action (known as “Product Trend Points”) in the overall calculation may be worth more or less depending on its importance.

Each product has a unique total number of “Product Trend Points” for each of the measured actions; this total number increases each time an action occurs. The more recent the action is, the more “Product Trend Points” the product gets. Similar to “Trend Score,” an action that occurred today is more valuable compared to an action that occurred one month ago, to the extent that the one month old action is worth nothing in the “Product Trend Score.” There is a base value that is constantly rising every second that is the same for every product within environment 100. When the product earns “Product Trend Points” from an activity, this constantly rising base value is included in the equation.

To calculate the “Product Trend Score” from the number of “Product Trend Points,” the “Product Trend Points” are compared to the base value that grows every second. This means that the “Product Trend Score” of an inactive product continues decreasing over time because the “Product Trend Points” earned a month ago are worth significantly less than “Product Trend Points” earned by other products one month later.

It would be technically possible for two products to have the same “Product Trend Score.” For granularity, “Product Trend Score” can be measured to the second decimal place. For example, a highly popular shoe can score around 95.21, whereas a less popular sportswear brand can score around 40.67.

As an example, the following actions can earn “Product Trend Points” that contribute towards the overall “Product Trend Score:” internal actions (e.g., the number of times the product has been purchased, added, viewed, liked, shared and/or commented on), the frequency of internal activity relating to the product (e.g., average number of purchases, adds, views, shares, likes, comments), and external actions (e.g., mentions of the product on Twitter®, Facebook®, Pinterest®, Youtube® or others, frequency of these product mentions, number of “likes” of product on Facebook®, mentions scraped from relevant Web sites (e.g., mentions of Air Yeezy on hypebeast.com in relation to men's shoes), and number of results on Google® shopping).

Similar to “Product Trend Score,” “Brand Trend Score” measures the popularity of a brand or merchant by tracking activity for various different types of internal actions (i.e., brand or merchant activity within environment 100) and external actions (i.e., brand activity measured from other Internet sources), and then distilling the total sum of actions into a more meaningful value ranging, for example, from 0 to 100, where 0 is least popular and 100 is most popular. The value of each action (known as “Brand Trend Points”) in the overall calculation may be worth more or less depending on its importance.

In an alternative embodiment, server 128 allows users to perform various missions to earn rewards and increase user activity. To complete these missions, users have to perform certain actions (e.g., add products, create lists, follow a brand, and invite friends). Users who have successfully completed a mission can earn rewards (e.g., points), an increase in their Trendsetter Score, or unlocking perks. Some missions might be brand-specific, as discussed above.

### Trendwatch

“Live Trendwatch” is a method to monitor influencers' sources for product and brand mentions, and surface these mentions on another site in a relevant format. In one embodiment, influencers include, but are not limited to, bloggers, magazines, and the like. As an example, server 128 can monitor, using the Trendwatch module 162, an influencer's social media (e.g., Twitter®) page. When this social media page mentions a keyword, such as a product name or a brand name, server 128 searches its own database 126 for products that match this keyword, and surfaces matching products to its users with an indication, for example, that the said product was “mentioned by the influencer on Twitter®.”

The system can monitor multiple sources of one influencer at once, including the influencer's social media platforms (e.g., Twitter®, Facebook®, Web site, APIs, Pinterest®, Tumblr®, editorialized articles, and any Web site holding the influencer's mentions of products and brands). Server 128 can then extract contextual information from that source through various ways, including checking for keywords and links on the source itself.

As an example, from the influencer's Twitter® Page the server 128 can: check tweets, using the Trendwatch module 162, for matching links in the database 126 to determine matching products; crawl links and find keywords on a Web page to match with products; extract keywords from a tweet and visited link; search the database 126 for products that match keywords; check for brands (e.g., “@mentioned”) on Twitter®; and gather a predetermined number of recent tweets of a specific account, search the tweets for keywords and phrases to generate tag clouds for the specific Twitter® handle, and search and tag the server 128 product catalogue module 153 for matching phrases and keywords.

More importance can be given to a mention from a source based on how reliable and popular the source itself is, for example, based on the sources' Alexa® rank. Thus, gathering mentions from a plurality of sources, server 128 determines which mention is indeed more important than the other. For example, for a Twitter® page, the following can be checked to determine its importance as a source: number of retweets for a tweet, number of followers, number of replies for a tweet, and age of account.

### Merchants Integration

Merchants can sign a partnership or an affiliate marketing agreement to add their products to the server's 128 product catalogue module 154 through an existing affiliate marketing network. When a click or purchase is generated on the merchant/advertiser's Web site, via a user's store, through the service of environment 100, the advertiser pays a commission to the affiliate. The affiliate retains a part of the commission and can reward the user/shopkeeper and the buyer. Advertisers are responsible for the purchase transaction and fulfillment. Accordingly, the environment 100 benefits advertisers by providing new return on investment sales channels, new advertising opportunities, an accountable presence in social media, and detailed analytics of sales and users. The advertisers pay a commission to be a part of the environment 100. The commissions may be paid by retailers to the system monthly or quarterly or on a minimum balance basis. Accordingly, server 128 provides the advantage of creating revenue for various advertisers that are tied to actual products or sales listed on server 128.

To effect a partnership or an affiliate marketing agreement, server 128 further includes a merchant integration module 152. When the merchants and partners enter into CPC or affiliate marketing agreements, merchant and/or partner is added in the merchant integration module 152. The retailer's goods may then be featured in the product catalogue module 154 and may be promoted by the user/shopkeeper in the store field 110. Merchants may select one of several different types of agreements, based on a tiered model with benefits associated with each tier, including the opportunity to purchase additional advertising at a discounted price and the like. The Product catalogue module 154 is filled with products based on affiliated merchant and partner product feeds.

The Merchant integration module 152 incorporates the merchant's products into the database 126 through a secure connection with the affiliate's platform. Once the merchant's product feed has been downloaded, a text-cleaning process is performed to ensure that all text is correctly encoded (e.g., UTF-8). New products are identified by the Merchant integration module 152—as each merchant's data is mapped with a central nomenclature. For specific merchants, data mapping can be overridden to increase accuracy of data import.

The Merchant integration module 152 categorizes the products and maps that category permanently within database 126. It stores new brands and allows server 128 to associate brands together under common nomenclature. The Merchant integration module 152 flags certain merchant categories for further human inspection (typically age restricted products such as alcohol, adult material or restricted products such as weapons). It either requires full review of the merchant category, or keyword based matches of specific products from the Product catalogue module 154 and database 126.

The Merchant integration module 152 also is configured to look for significant changes in product data—price fluctuations over a certain percentage, missing data where, missing titles, descriptions, etc. The module 152 flags these changes and indicates whether the feed needs further review by humans. Products are matched and assigned time-specific, price-specific promotions from data coming separately (e.g., through e-mail) from merchants.

### Merchant Analytics

Benefits associated with certain tiers discussed above can further include access to detailed analytics in a merchant analytics module 156 of server 128. The merchant analytics module 156 may generate various reports or other information requested by a merchant associated with the Web site 106.

Benefits associated with certain tiers discussed above might also include the possibility of registering certain merchants as users of the Web site 106, thereby enabling the merchants to create dedicated stores within the Web site 106. This provides the advantage for allowing merchants to customize their store—including how products are displayed—and add content.

### Search Field

In an embodiment, the Web site 106 may further include a search field 114. Information regarding these products or items may be stored in the database 126 from the Product catalogue module 154 which may be searched. For example, a description of the item, metadata (tags, etc), the price of the item, and information regarding a merchant linked to the item may be stored in the database 126. A user may search for these items by entering information about a particular item in the search field 114. In an embodiment, a search module 136 accesses the database 126 to locate information regarding additional users, products or services entered into the search field 114. A user enters search terms for another user, merchant, brand, item, list, tag, etc. Similarly, a user may enter information regarding a company or a product in the search field 114. For example, a user may desire to locate companies that produce a certain product or provide a particular service. The user may enter information regarding the type of product or service into the search field 114 in order to locate information regarding companies that provide the products or service. Information regarding promotional or merchandising tools may be stored in the database 126 from the User communication module 144 which may be searched.

The search module 136 may include, but is not limited to, the following functionalities in Table 5. The functionalities in Table 5 are associated with the category of navigation.

TABLE 5
Example navigational functionality associated with search module 136

| Feature | Objective/Benefit |
|---|---|
| Discovery/Serendipity Button | Surface stores to users, editorially promote quality |
| | stores to drive sales; |
| | Discover new products outside the user's social |
| | network |
| Recommendation tool (“people who | Help users edit available products; |
| bought/looked/rated similar also did this”) | Discover new products; |
| | Surface products to users based on their interests |
| | and their activity and the activity of their friends or |
| | the people that have similar interests |
| Entry Page Personality/Messaging; | Allow user to control browsing/shopping |
| User self-selects (e.g., “Looking for | experience; |
| friends/Looking for something/Just | Create a voice/personality for Web site 106 |
| Looking”) | |
| Geo-search for stores run by users around | Users self-define what culture they identify with; |
| the world | Cross promote retailers in other locations |
| Surface stores run just by my friends | Highlight products in the user's social network for |
| | recommendations the user is more likely to trust |
| Users help others find specific products | Encourage user contacts inside/outside of social |
| (“I need a great pair of dry pants for golf | networks |
| in rain”) | |

In one embodiment, the search module 136 further comprises an open source search engine 138. The open source search engine 138 weighs: explicit recommendations from users, friends, or followers; implicit recommendations from users, friends or followers; overall popularity of the product; and historical key word searches. Additionally, the open source search engine 138 weighs the following attributes of products available in the product catalogue module 154, the database 126, or in the user's store in the store module 132: (a) if any of the user's friends or follower's stock the item in their store (an implicit recommendation); (b) if any of the people the user has followed have stocked the product in their stores (an implicit recommendation); (c) the overall popularity of the products (e.g., how many views the product has received within environment 100); and (d) simple keyword matches to the search term in the database 126. In the display results from a search using the search field 114 and search module 136, information from the open source search engine 138 organizes products by order of social relevance.

In addition to an open source search engine 138, the search module 136 further includes a filter module 140. The filter module 140 can filter the products returned by the search module 136, based on their category, enabling the user to refine their search results.

### User Interface Illustrations

FIG. 2A illustrates one embodiment of a user interface 200. As illustrated, the user interface 200 includes a customized “following” feed showcasing products recently added by other users and categories or brands that the user follows. The interface 200 also includes a Trendsetter score 201, a mission bar 202, a “Following” button 240 (which allows the user/shopkeeper to view all the users/brands/categories the user is following), and a “You might like” button 250 (which recommends stores and brands to the user based on their browsing activity). Trendsetter Score 201 is the total Trendsetter Points earned by a user in the lifetime of their account, distilled into a value as described above.

The user interface 200 may further include a user account dashboard 230, which may be an individual place for users to check the balance of their account (cash earnings, points), any notifications they received and access their own storefront. The user account dashboard 230 illustrated includes an earnings balance 203, a points balance 204, a profile image button 205 (which shows the current view of the store), and a notifications feed 206 that updates the user with quick notifications based on the activity of both the current user and other active users. In another embodiment, the user account dashboard 230 may be in the form of a widget or may be transportable to a mobile application.

Each thumbnail shown (e.g., product thumbnail 208) includes various details of the product (e.g., brief description and retail price), the social currency 209 (i.e., indicating the number of views, adds, and comments the specific product has received), and a social activity chain 210 (i.e., recent users who have added the product and recent comments with a thumbnail of the respective user). Some thumbnails may be tactically placed based on external agreements between merchants, for example (e.g., missile thumbnail 207 displaying an advertising banner).

In one embodiment, advertisers are given the opportunity to bid (e.g., on a CPC or CPM basis) to feature certain products, lists of products, or banners in certain users' following feed. This enables advertisers to target users based on a number of criteria including, but not limited to, profile interests and activity within the Web server 163 or other social networks.

In an alternative embodiment, the user interface 200 may further include a currency tool (not shown) that allows users to view account balances in one currency (users may promote products that are sold in multiple currencies), a payment system to users (not shown) that assists users in managing payments, a cash-out button (not shown) to redeem earnings or give to charity, and an add coins button (not shown) that allows users to add points into their personal account.

An alternative embodiment of user interface 250 is illustrated in FIG. 2B. User interface 250 includes a profile bar 221 that displays an example of a user's/shopkeeper's profile photo and name 211. The profile bar 221 further includes an example of the user/shopkeeper's store tagline 212, an “Edit Assistant” button 213, and an “Edit Theme” button 214 (which allows for changes to the store's background, font, colors and the like). A following area 215 for showing the user's friends currently using the system and other stores the user is following, a follower area 216 showing other users that are following the user/shopkeeper, and a “You might like” area 217 showing people and brands that the user might like are also shown.

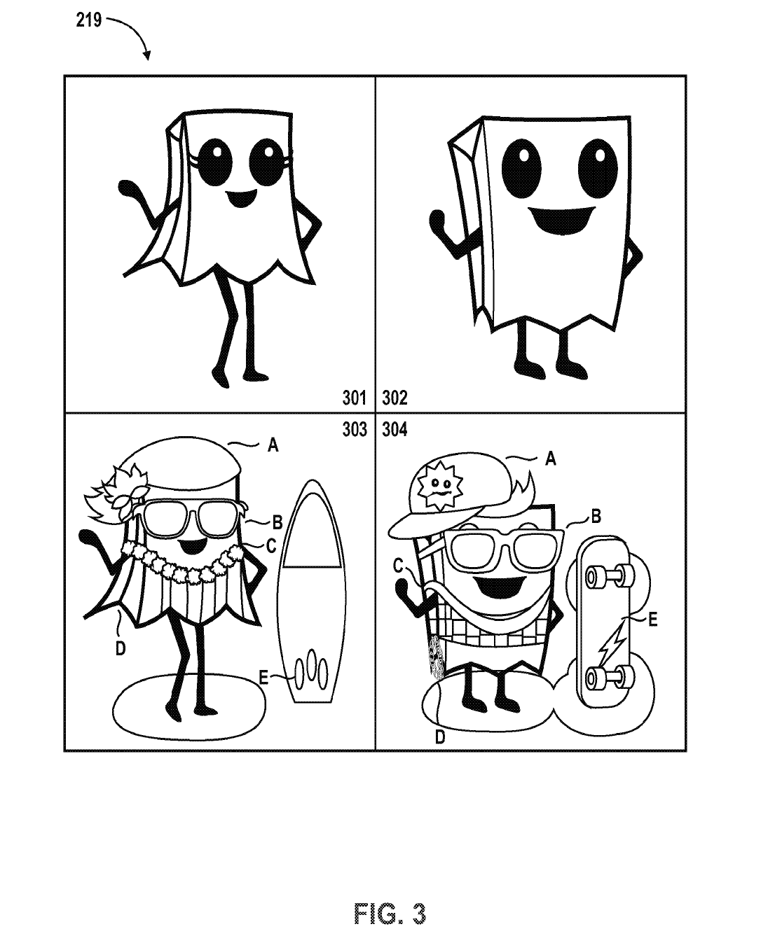

The embodiment of the user interface 250 in FIG. 2B also displays a main storefront. The main storefront includes an add product button 220 that allows the user/shopkeeper to add more products in the product catalogue through product catalogue module 154 of server 128. In one embodiment of the user interface 250, the user is able to group different products into one list 218, which provides thumbnail images of recent products added to the list. This embodiment also features a virtual store assistant character 219 (shown in detail in FIG. 3), which represents a customizable avatar associated with a user profile.

### Avatar Illustration

As previously mentioned, FIG. 3 illustrates various examples of the virtual store assistant character 219 from one embodiment of the user interface 250. The virtual store assistant character 219 is illustrated as a general bag shape in 301, 302, 303 and 304. The virtual store assistant characters 301, 302, 303 and 304 include changeable assets, such as color, head accessories, face accessories, body accessories, outfits and toys the character can interact with. In one embodiment, virtual store assistant character 301 is the default female character while virtual store assistant character 302 is the default male character. The virtual store assistant character 303 is an example of a fully outfitted female character with head accessories 303A, face accessories 303B, body accessories 303C, an outfit 303D and a toy 303E. The virtual store assistant character 304 is an example of a fully outfitted male character with head accessories 304A, face accessories 304B, body accessories 304C, an outfit 304D and a toy 304E.

### Computer Architecture Illustration

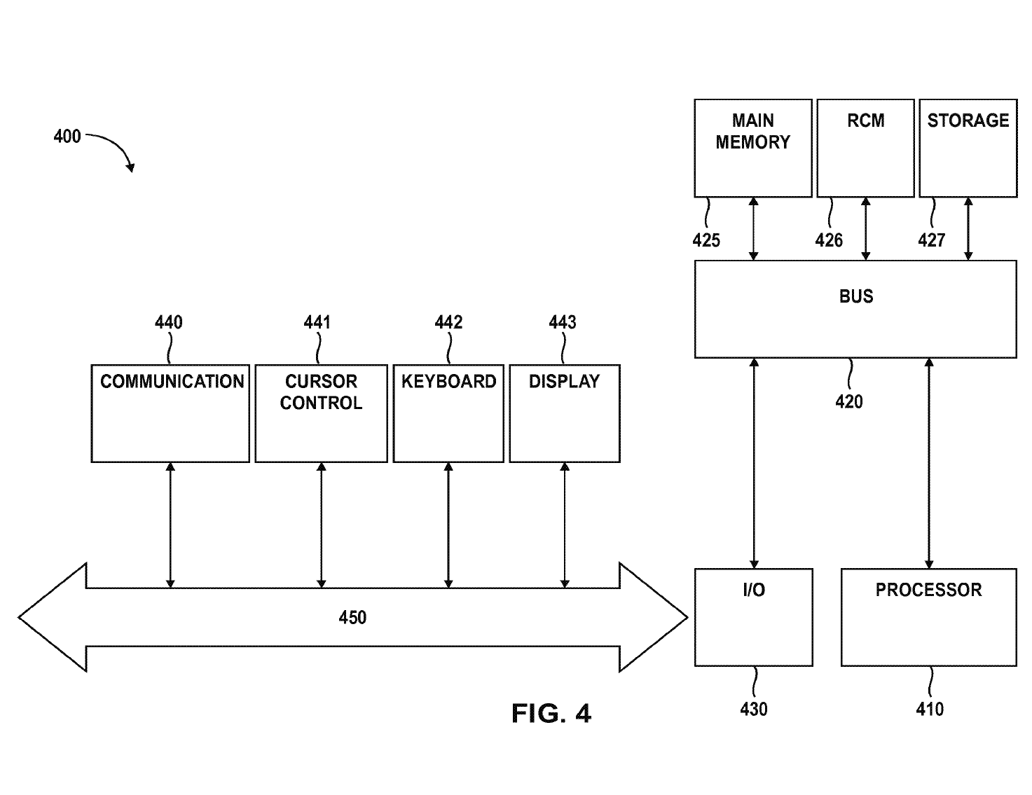

FIG. 4 illustrates an exemplary computer architecture for use with the present system, according to one embodiment. Computer architecture 400 can be used to implement the Web server 163, the database 126 and server 128 of FIG. 1. One embodiment of architecture 400 comprises a system bus 420 for communicating information and a processor 410 coupled to the bus 420 for processing information. Architecture 400 further comprises a random access memory (RAM), or other dynamic storage device 425 (referred to herein as main memory), coupled to bus 420 for storing information and instructions to be executed by processor 410. Main memory 425 also may be used for storing temporary variables or other intermediate information during execution of instructions by processor 410. Architecture 400 also may include a read only memory (ROM) and/or other static storage device 426 coupled to bus 420 for storing static information and instructions used by processor 410.

A data storage device 427 such as a magnetic disk or optical disc and its corresponding drive may also be coupled to computer system 400 for storing information and instructions. Architecture 400 can also be coupled to a second I/O bus 450 via an I/O interface 430. A plurality of I/O devices may be coupled to I/O bus 450, including a display device 443, an input device (e.g., an alphanumeric input device 442 and/or a cursor control device 441). For example, Web pages 106 and related information may be presented to the user on the display device 443.

Communication device 440 allows for access to other computers (e.g., servers or clients) via a network (e.g., network communication 158). Communication device 440 may comprise a modem, a network interface card, a wireless network interface, or other well-known interface devices, such as those used for coupling to Ethernet, Token Ring or other types of networks.

Some portions of the detailed descriptions provided are presented in terms of algorithms and symbolic representations of operations on data bits within a computer's memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the aforementioned discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms presented herein are not inherently related to any particular computer or other apparatus. Various general purpose systems, computer servers or personal computers may be used with programs in accordance with the teachings herein, or it may prove convenient to construct a more specialized apparatus to perform the required method steps. The required structure for a variety of these systems appears from the description above. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes of the components.

It will be evident that various modifications and changes may be made thereto without departing from the broader spirit and scope of the disclosure. For example, the reader is to understand that the specific ordering and combination of process actions described herein is merely illustrative, and the disclosure may be performed using different or additional process actions or a different combination or ordering of process actions. For example, this disclosure is particularly suited for electronic commerce, however, the disclosure can be used for a variety of services such as dating networks and service bookings including, but not limited to, hotels, restaurants, health and beauty treatment, cultural events, sports, and so on. Additionally and obviously, features may be added or subtracted as desired. Accordingly, the invention is not to be restricted except in light of the attached claims and their equivalents.

What is claimed is:

1. A computer-implemented method for providing rewards to a user and a customer via social shopping using game mechanics associated with a networking Web site, comprising:
receiving identification information for the user;
receiving product information relating to one or more products from a merchant affiliate;
creating a personalized store for the user that displays the product information related to the one or more products, such that the customer from the networking Web site can browse the one or more products displayed in the user's store from the merchant affiliate and has an option to purchase the one or more products;
providing a search engine for searching the product information related to the one or more products; and
distributing the rewards to the user and to the customer when the customer or user performs an activity relating to the one or more products.

2. The computer-implemented method of claim 1, wherein the activity relating to the one or more products is at least one of the customer making a purchase of the one or more products and the user establishing a virtual association with the customer.

3. The computer-implemented method of claim 1, wherein the user is enabled to customize the user's personalized store.

4. The computer-implemented method of claim 3, wherein the user is enabled to customize their personalized store by creating a list of the one or more products from the merchant affiliate.

5. The computer-implemented method of claim 3, wherein the user is enabled to customize the personalized store by providing games related to the one or more products from the merchant affiliate to the customer.

6. The computer-implemented method of claim 5, wherein the activity relating to the one or more products includes the customer playing the games provided from the personalized store.

7. The computer-implemented method of claim 1, further comprising enabling a discovery of one or more new products from the merchant affiliate based on the identification information for the user.

8. The computer-implemented method of claim 1, further comprising calculating a “trend score” for each of the user, the one or more products from the merchant affiliate, the merchant affiliate, and a brand of the one or more products based on popularity.

9. The computer-implemented method of claim 8, wherein the “trend score” of the user is increased by playing a game related to the one or more products from the merchant affiliate to the customer.

10. The computer-implemented method of claim 8, wherein the search engine further provides a listing of at least one of the one or more products, the users, the brands, and the merchant affiliates having the highest “trend score.”

11. The computer-implemented method of claim 1, further comprising receiving recommendations from the user, wherein the recommendations include selected products from the one or more products from the merchant affiliate; and providing the recommendation of the selected products to the customer.

12. The computer-implemented method of claim 1, further comprising providing analytics related to the one or more products to the merchant affiliate.

13. The computer-implemented method of claim 1, further comprising displaying a “trendwatch” feed, wherein the “trendwatch” feed includes a list of the one or more products that are published on the networking Web site.

14. A system for providing rewards to a user and a customer using one or more consumer computing devices over a data network via social shopping using game mechanics associated with a networking Web site, comprising:
a registration module for receiving identification for the user;
a product catalogue module for receiving product information relating to one or more products from a merchant affiliate over the data network;
a store module in communication with the product catalogue module and the registration module for creating a personalized store for the user that displays the product information related to the one or more products received via the product catalogue module, such that the customer from the networking Web site can browse the one or more products displayed in the user's store from the merchant affiliate and has an option to purchase the one or more products;
a search module in communication with the product catalogue module for providing an open source search engine to search the product information related to the one or more products; and
a rewards module in communication with the registration module for distributing the rewards over the data network to the one or more consumer computing devices of the user and the customer when the customer or user performs an activity relating to the one or more products displayed in the user's store.

15. The system of claim 14, wherein the activity relating to the one or more products is at least one of the customer making a purchase of the one or more products and the user establishing a virtual association with the customer.

16. The system of claim 14, wherein the store module is further configured to customize the personalized store.

17. The system of claim 16, wherein customizing the personalized store is at least one of creating a list of the one or more products and providing games related to the one or more products to the customer.

18. The system of claim 14, wherein the store module is further configured to suggest one or more new products from the merchant affiliate to the user based on the identification information for the user.

19. The system of claim 14, further comprising a trend score module in communication with the registration module and the product catalogue module for calculating a “trend score” for each of the user, the one or more products from the merchant affiliate, the merchant affiliate, and a brand of the one or more products based on popularity.

20. The system of claim 19, wherein the search module is in communication with the trend score module, and is further configured to provide a listing of at least one of the one or more products, the users, the brands, and the merchant affiliates having the highest “trend score.”
